(19) United States
(12) Patent Application Publication
(10) Pub. No.: US 2009/0074120 A1
(43) Pub. Date: Mar. 19, 2009

(54) AUTO-CALIBRATION FOR A FILTER

(75) Inventors: Zabih Toosky, Santa Cruz, CA (US); Ann P. Shen, Saratoga, CA (US)

Correspondence Address: FISH & RICHARDSON P.C., P.O. BOX 1022, MINNEAPOLIS, MN, 55440-1022, US

(73) Assignee: NANOAMP SOLUTIONS INC., Santa Clara, CA (US)

(21) Appl. No.: 12/209,878

(22) Filed: Sep. 12, 2008

Related U.S. Application Data
(60) Provisional application No. 60/971,760, filed on Sep. 12, 2007.

(51) Int. Cl. H04B 1/10

(52) U.S. Cl. 375/350; 327/553; 327/554

(57) ABSTRACT

A filter is configured to receive a filter charging signal and to produce a filter output signal based on the filter charging signal. The filter includes an element array with one or more switched elements which include an element and a switch configured to connect the element to or disconnect the element from the array, thereby altering a time constant of the filter. A comparator is configured to receive the filter output signal and a reference signal corresponding to a value of the filter output when the time constant has a defined value, and to generate a comparator output signal based on a comparison of the filter output signal to the reference signal. A controller is configured to receive the comparator output signal and, based on the comparator output signal, output an array control signal configured to adjust one or more switches of the one or more switched elements of the element array to alter the time constant such that a value of the time constant approaches the defined value.

### CROSS REFERENCE TO RELATED APPLICATIONS

This application claims the benefit of priority from U.S. Provisional Application entitled “AUTO-CALIBRATION FOR AN ACTIVE RC FILTER,” Application No. 60/971,760 filed Sep. 12, 2007, the disclosure of which is incorporated by reference.

### TECHNICAL FIELD

This disclosure relates to calibrating a filter.

### BACKGROUND

Capacitors and resistors can be used in filters. If the capacitance of a filter's capacitor or the resistance of a filter's resistor is different than expected, the time constant or other filter characteristic can also be different than expected.

### SUMMARY

According to one general aspect, a circuit includes a filter configured to receive a filter charging signal and to produce a filter output signal based on the filter charging signal. The filter includes an element array with one or more switched elements and each switched element includes an element and a switch configured to connect the element to or disconnect the element from the array such that connecting elements to or disconnecting elements from the element array alters a time constant of the filter. The circuit also includes a comparator configured to receive the filter output signal and a reference signal and to generate a comparator output signal based on a comparison of the filter output signal to the reference signal. The reference signal corresponds to a value of the filter output when the time constant has a defined value. The circuit further includes a controller configured to receive the comparator output signal and, based on the comparator output signal, output an array control signal configured to adjust one or more switches of the one or more switched elements of the element array to alter the time constant such that a value of the time constant approaches the defined value.

These and other implementations can optionally include one or more of the following features. For example, the element array can be a capacitor array and each switched element can include a capacitor and a switch. The circuit can include a fixed capacitor coupled in parallel to the capacitors of the capacitor array such that the fixed capacitor is not within a switched element of the capacitor array. The circuit also can include a discharge switch coupled to the capacitor array and the fixed capacitor and configured to discharge the fixed capacitor and the capacitors of the one or more switched capacitors based on a discharge signal. The circuit further can include a discharge switch coupled to the capacitor array and configured to discharge the capacitors of the one or more switched capacitors based on a discharge signal.

The array control signal can be an “n” bit signal and each bit can be coupled to a respective control input of each switch of the switched elements, where “n” is the number of switched elements. The controller can be configured to adjust, sequentially over “n” one bit adjustment cycles, each bit of the “n” bit array control signal based on the comparator output signal. The controller can be configured to output the array control signal to one or more additional element arrays which are connected to one or more additional filters. The one or more additional filters can include a k-pole RC filter. The reference signal can be a voltage which would be output by the filter at the time the comparator generates a comparator output signal if the value of the time constant of the filter is equal to the defined value.

The controller can include a successive approximation register. The controller can include a state machine. The circuit can include a timing generator configured to receive a system clock signal and to generate the filter charging signal, a comparator control signal, and a controller control signal based on the received system clock. The filter charging signal and the controller control signal can be generated as one signal output which is received at to both the filter and the controller. The filter can be a single-pole RC-filter. The circuit can include a voltage divider to generate the reference signal as a ratio of a supply voltage.

According to a second general aspect, a method comprises applying a filter charging signal to an input of a filter to produce a filter output based on the filter charging signal. The filter includes an element array with one or more switched elements, each switched element including an element and a switch configured to connect the element to or disconnect the element from the array such that connecting elements to or disconnecting elements from the element array alters a time constant of the filter. The method also includes applying the filter output to a first input of a comparator and applying a reference signal to a second input of the comparator. The reference signal corresponds to a value of the filter output when the time constant has a defined value. The method further includes comparing the filter output to the reference signal using the comparator to generate a comparator output signal and applying the comparator output signal to a controller. The method additionally includes adjusting, with the controller and based on the comparator output signal, one or more switches of the one or more switched elements of the element array to alter the time constant based on the comparator output such that a value of the time constant approaches the defined value.

These and other implementations can optionally include one or more of the following features. For example, the element array can be a capacitor array and each switched element can include a capacitor and a switch. The filter can include a fixed capacitor outside of and coupled in parallel to the switched elements of the capacitor array. The method can include discharging the fixed capacitor and the capacitors of the one or more switched capacitors with a discharge signal input to a discharge switch coupled to the capacitor array and the fixed capacitor. The method also can include discharging the capacitors of the one or more switched capacitors with a discharge signal input to a discharge switch coupled to the capacitor array.

The method further can include generating, at the controller, an “n” bit array control signal such that each bit of the array control signal is coupled to a respective control input of each switch of the switched elements and “n” is the number of switched elements. The method can additionally include adjusting, sequentially over “n” one bit adjustment cycles, each bit of the “n” bit array control signal based on the comparator output signal. Furthermore, the method can include applying the array control signal to one or more additional element arrays which are connected to one or more additional filters.

The one or more additional filters can include a k-pole RC filter. The reference signal can be a voltage which would be output by the filter at the time the comparator generates a comparator output signal if the value of the time constant of the filter is equal to the defined value. The controller can include a successive approximation register. The controller can includes a state machine. Also, the method can include receiving a system clock signal at a timing generator and generating, at the timing generator and based on the received system clock signal, the filter charging signal, a comparator control signal, and a controller control signal. Generating the filter charging signal and the controller control signal can include generating one signal output which is received at both the filter and the controller. The filter can be a single-pole RC-filter. Further, the method can include generating the reference signal as a ratio of a supply voltage with a voltage divider.

According to a third general aspect, a system comprises a radio frequency (RF) input signal received by an antenna coupled to an RF filter and a low noise amplifier (LNA) configured to amplify the RF input signal after it has been received by the antenna. The system also includes a mixer configured to perform image rejection and mix, with an output of a first local oscillator, the RF input signal after it has been amplified by the LNA. The system further includes a first filter configured to filter the RF input signal after it has been mixed by the mixer such that the first filter includes a first element array which is configured to be adjusted based on an array control signal from an array controller and a second filter configured to filter the RF input signal after it has been filtered by the first filter such that the second filter includes a second element array which is configured to be adjusted based on the array control signal from the array controller. The system additionally includes a calibration filter configured to receive a calibration filter charging signal and to produce a calibration filter output signal based on the calibration filter charging signal. The calibration filter includes a calibration element array with one or more switched elements, each switched element including an element and a switch configured to connect the element to or disconnect the element from the calibration element array. Moreover, the system includes a comparator configured to receive the calibration filter output signal and a reference signal and to generate a comparator output signal based on a comparison of the calibration filter output signal to the reference signal. Ma controller configured to receive the comparator output signal and, based on the comparator output signal, output the array control signal such that the array control signal is configured to adjust one or more switches of the first, second, and calibration element arrays.

The details of one or more implementations are set forth in the accompanying drawings and the description below. Other features will be apparent from the description and drawings, and from the claims.

### DESCRIPTION OF THE DRAWINGS

FIG. 1 is a schematic of an example of a single pole low-pass RC filter.

FIG. 2A is a schematic of an example of an active, two-pole, low-pass RC filter.

FIG. 2B is a schematic of an example of an active, two-pole, low-pass RC filter with a switching capacitor array.

FIG. 3 is a schematic of an example of an RC filter with auto-calibration.

FIG. 4 is a diagram of an example of timing signal generation.

FIG. 5 is a block diagram of an example of a process for auto-calibration of a filter.

FIG. 6 is a schematic of an example of a low intermediate frequency receiver.

FIG. 7 is a schematic of an example of a direct-conversion receiver.

### DETAILED DESCRIPTION

Resistor-capacitor (RC) filters are used commonly in a number of applications, such as in wired and wireless communication, audio and video, as well as in medical systems. An RC filter may be included in both the transmitter and receiver blocks of communications systems. In the receiver block, input signals can have a wide range of amplitudes, and filtering of unwanted signals may aid in properly decoding an input signal's information. In the transmitter block, the transmitter signal levels may be filtered in order to improve signal fidelity or reduce interference.

Due to semiconductor processing and temperature variations of resistors and capacitors, RC filters integrated on chips can have time constant tolerances of ±20% or more. Such tolerances can create issues if they do not meet the accuracy requirements of some communication systems. For example, in various circumstances, the capacitor tolerance requirement for the full-type test acceptance (FTA) of Wideband Code Division Multiple Access (WCDMA) handset is about 2.5%. The time constant tolerance of many electronic and semiconductor systems can be reduced by using a combination of an accurate signal source, such as a clock signal derived from a high accuracy crystal oscillator, a digitally switching array of capacitors, and/or a provision for compensating for analog errors and calibration.

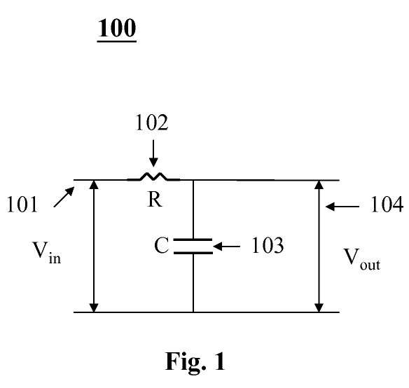

FIG. 1 shows a schematic of an example of a passive, single pole low-pass RC filter 100 with a resistor 102 of value R in series with a capacitor 103 of value C. A passive filter includes only passive components, such as resistors, capacitors, and inductors, and can often be simple in design. A passive filter also can provide a simple one pole or two pole filter with an easily calculated filter response. In the filter 100, an analog voltage Vᵢₙ is applied to a terminal 101 of the resistor 102 and a second terminal of the resistor 102 is connected in series with the capacitor 103. An output voltage Vₒᵤₜ at an output terminal 104 is taken across the capacitor 103 for a low-pass filtering function. If, instead, the output voltage is taken across the resistor 102, the filter 100 performs as a high pass filter. A cutoff frequency f_{c} of the filter 100 is equal to 1/(2π*τ) where the time constant τ is defined by τ=R*C.

When a passive filter, such as the filter 100, does not meet system requirements, an active component, such as an operational amplifier, can be added to produce an active-RC filter. Active-RC filters can be used to design a second order filter.

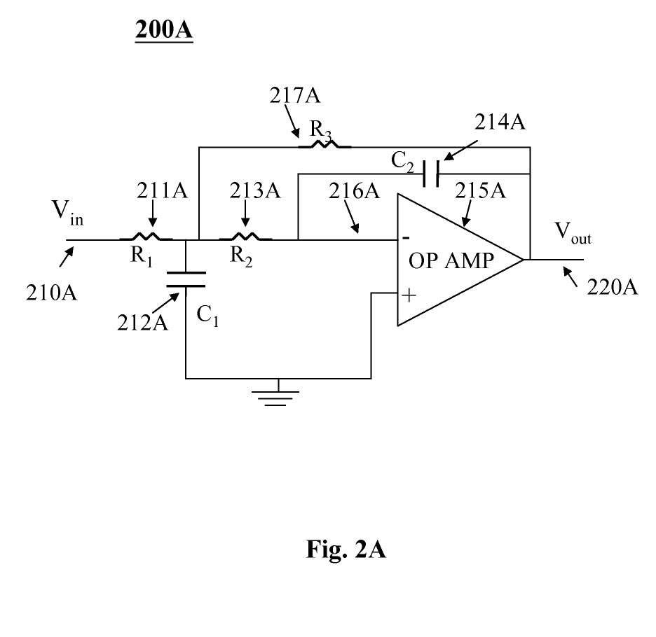

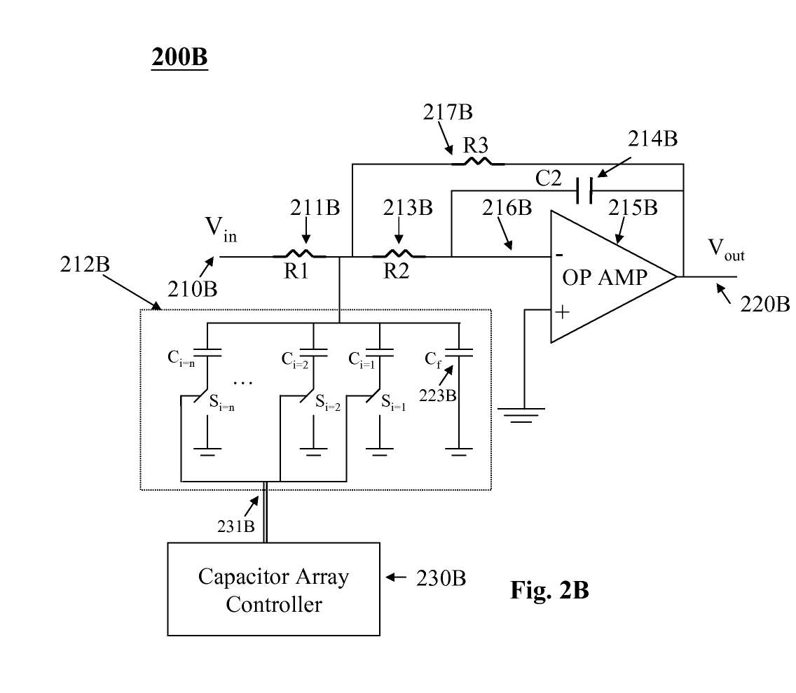

FIG. 2A shows a schematic of an example of an active two-pole, low-pass, RC filter 200A. In the filter 200A, an analog voltage Vᵢₙ is applied as an input voltage at an input terminal 210A of a resistor 211A having a resistance value R₁. The filter 200A also includes a two-stage RC network which cascades two series RC circuits with the first resistor 211A. The two series RC circuits include a first capacitor 212A of capacitance C₁, a second resistor 213A of resistance R₂, a second capacitor 214A of capacitance C₂, and a third resistor 217A of resistance R₃.

An operational amplifier 215A includes an inverting input that is coupled to an output 216A of the RC filter, which is the output of the second resistor 213A. The operational amplifier 215A also includes a non-inverting input coupled to ground. An output voltage Vₒᵤₜ at an output terminal 220A of the operational amplifier 215A is coupled-back to the second capacitor 214A and to the third resistor 217A to make a Sallen-Key active-RC filter. Second order filters can be used as the building blocks of higher order filters by cascading multiple stages of second order filters. Due, for example, to component and temperature variations, when fixed capacitors and resistors are used in the filter 200A, the filter 200A may not have high tolerances (e.g., less than ±5%). Replacing the fixed value capacitors with switch-capacitors may improve the tolerances of the filter 200A.

FIG. 2B shows a schematic of an example of an active two-pole, low-pass RC filter 200B with a switching capacitor array. The filter 200B shown in FIG. 2B is similar to the filter 200A shown in FIG. 2A although the fixed capacitor 212A is now replaced by a capacitor array 212B. The capacitor array 212B includes a fixed value C_{f} parallel capacitor 223B and “n” elements of parallel switched capacitors of decreasing values. The filter 200B also includes an input terminal 210B, an operational amplifier 215B, a filter output 216B, an operation amplifier output terminal 220B, resistors R₁ 211B, R₂ 213B, and R₃ 217B, capacitor C₂ 214B

Each of the “n” elements of the capacitor array 212B includes a capacitor Cᵢ and a digitally controlled switch Sᵢ for each of i=1, 2, . . . n. The capacitance value of each capacitor Cᵢ decreases as “i” increases and are weighted values of a unit capacitance Cᵤₙᵢₜ. The value “n” is the number of bits of the digital switch control signal 231B generated by a capacitor array controller 230B and is a positive integer. The digital switch control signal 231B can close a switch Sᵢ when, for example, it is “high” or equivalent to a digital 1. The total capacitance of the RC filter is the sum of the fixed capacitance C_{f} and the capacitance of all capacitor-switch capacitors with closed switches. Alternatively, a capacitor array with serially arranged switched capacitors also can be used to improve RC filter performance. A calibration scheme can be performed, for example, at device startup or after manufacturing to determine the appropriate value of signal 231B to provide a total capacitance that places the filter 200B within a desired tolerance. The controller 230B can then be set with this value.

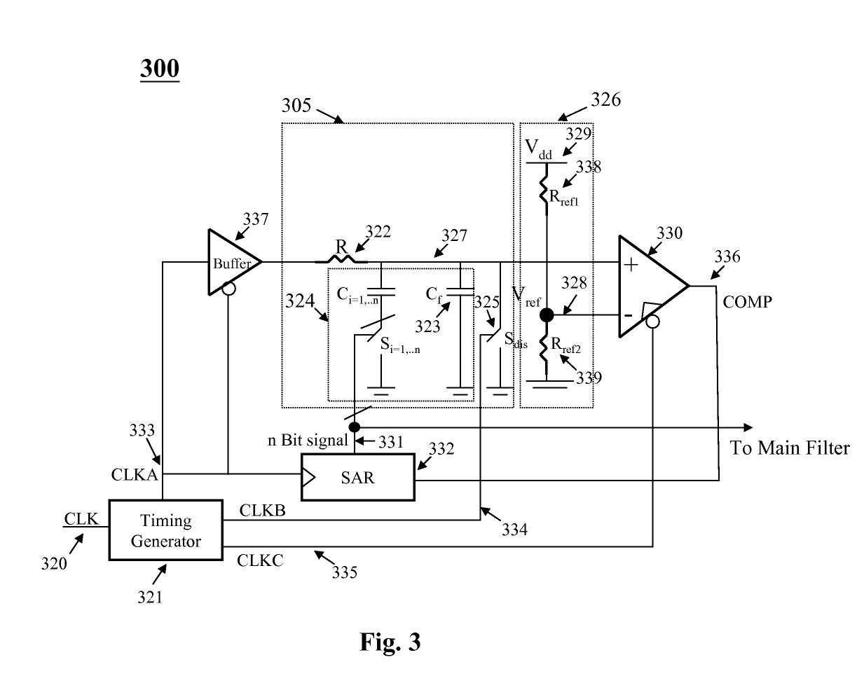

FIG. 3 is a schematic of an example of an auto-calibration filter 300 that can be used, for example, after manufacturing or at device startup to determine the appropriate value of signal 231B. The filter 300 includes a one-pole RC filter formed from a resistor R 322 and a capacitor array 324. The capacitor array 324 includes a fixed value capacitor C_{f} 323 and “n” elements includes a capacitor Cᵢ and a digitally controlled switch Sᵢ for each of i=1, 2, . . . n. The capacitance value of each capacitor Cᵢ decreases as “i” increases, and are weighted values of a unit capacitance Cᵤₙᵢₜ (e.g., C₁=16*Cᵤₙᵢₜ for i=1, C₂=8*Cᵤₙᵢₜ for i=2, C₃=4*Cᵤₙᵢₜ for i=3, C₄=2*Cᵤₙᵢₜ for i=4, and C₅=1*Cᵤₙᵢₜ for i=5). The value “n” is the number of bits of a digital switch control signal 331 and is a positive integer (e.g., 5). The control signal 331 is generated by a controller, such as a successive approximation register (SAR) 332. The control signal 331 can close a switch Sᵢ when, for example, it is “high” (e.g., equivalent to a digital 1).

A time constant of the filter 300 is RC, where C is the total capacitance of the capacitor array 324. The fixed value capacitor C_{f} 323 can be a weighted unit capacitor with a pre-determined largest value of all capacitors in the capacitor array 324 (e.g., 32*Cᵤₙᵢₜ). Each of the capacitance values of the parallel capacitors Cᵢs can be made successively smaller, from i=1,2 . . . n. A summation of C_{f}+Σ_{i=1 . . . n}Cᵢ is equal to the total targeted capacitance C. The unit capacitance Cᵤₙᵢₜ can be the same as the unit capacitance used in a scaled capacitor array in a main filter employed in the device (e.g. the array 212B in the filter 200B). The main filter can be of a higher order or multiple stages of higher order filters than filter 300. For example, when the filter 200B is used as the main filter, the main filter is a second order filter while the filter 300 is a single order filter. Also, the main filter and the filter 300 can be formed on the same chip using the same fabrication process.

A filter output 327 of the filter 300 is connected to the non-inverting input of a comparator 330. A voltage divider 326 is used for a reference voltage and is connected to the inverting input 328 of the comparator 330. The voltage divider 326 receives voltage V_{dd} at a first terminal 329 of the voltage divider 326, and includes two reference resistors 338 and 339 with resistance values R_{ref1} and R_{ref2}, respectively. The reference voltage V_{ref} at the inverting input 328 of the comparator 330 is equal to V_{dd}*R_{ref2}/(R_{ref1}+R_{ref2}). R_{ref1}, and R_{ref2} can be configured to provide a value of V_{ref} that enables tuning of the filter 300 to a predetermined time constant. The reference voltage can be set at, for example, 45% of the resistor divider, a reference voltage=0.45 Vdd. A discharge switch S_{dis} 325 is connected between the filter output 327 and a ground for discharging the fixed capacitor C_{f} and the switching capacitors Cᵢs in the capacitor array 324.

A timing generator 321 generates clock signals CLKA 333, CLKB 334, and CLKC 335 from the clock CLK 320 coupled to an input of the timing generator 321. CLKA 333 is coupled to an input of the filter 300 via a buffer 337 which is controlled by a negative edge of the CLKA 333. CLKA 333 also controls a successive approximation register (SAR) 332. CLKB 334 controls the discharge switch S_{dis} 325. CLKC 335 controls the comparator 330. An output signal COMP 336 of the comparator 330 is coupled to an input of the SAR 332 to apply a successive-approximation algorithm to generate the n-bits of the control signal 331 for controlling the switches Sᵢ where i=1, 2 . . . n of the capacitor array 324.

In some implementations, the auto-calibration is performed at the initialization of operation, or “power up” of the device to, for example, correct for manufacturing process variation and/or temperature variation. Values of capacitors in the capacitor array 324 can be equal to C_{f}=0.5*C=2ⁿ*Cᵤₙᵢₜ and Cᵢ=2⁽ⁿ⁻ⁱ⁾* Cᵤₙᵢₜ with i=1, . . . , n with i=1 being the most significant bit (MSB) and i=n being the least significant bit (LSB).

In some implementations, at power up, the initial switch position is closed for C₁ and open for the rest of the capacitors (C_{i=2, . . . , n}=0). The capacitor array 324 is charged during the clock high period of CLKA 333 with a current through resistor 322 created by applying the rising edge of CLKA 333 of voltage V_{dd} to the filter 300 through the buffer 337. During charging (e.g., when the buffer 337 is enabled), the voltage at the filter output 327 or the non-inverting input of the comparator 330 is Vₒᵤₜ(t)=V_{dd}*[1−exp(−t/RC)] at time “t.” At the falling edge of CLKA 333, the buffer 337 is disabled and the voltage is held (it is latched due to the buffer 337 being disabled). The filter output voltage Vₒᵤₜ can then be compared with the reference voltage V_{ref} at inverting input 328 by the comparator 330 to determine whether the filter output 327 voltage Vₒᵤₜ is higher or lower than the reference voltage V_{ref}.

The filter output 327 voltage Vₒᵤₜ is a function of the filter's time constant. If the filter 300 exhibits the desired time constant, the filter output 327 should have a voltage Vₒᵤₜ equal to V_{ref} at a given point in time. The comparator 330 determination reflects the difference between the filter output voltage Vₒᵤₜ and V_{ref}, and, thus, reflects the need to increase or decrease the capacitance of the filter 300 to achieve the desired time constant.

The SAR 332 then sets a bit of the n-bit control signal 331 for the MSB depending on whether the output signal COMP 336 is high or low. The SAR 332 can include a state machine with a state to process the received output signal COMP 336 signal and prepare the next control signal 331 and a state to later set or update the control signal 331. The discharge switch S_{dis} 325 is controlled by the interleaving CLKB 334 and can discharge the capacitor array 324 before a new processing cycle starts. The process can continue for “n” cycles to determine the setting of each bit of the control signal 331 to provide a final tuning setting to meet a system tolerance requirement for the main active-RC filter (e.g., the filter 200B).

In some implementations, only the discharge cycle discharges the charged capacitors. In other implementations, the SAR 332 sets the control signal 331 to all 1's to close all switches during the discharge cycle to discharge all the capacitors. After the discharge cycle is completed, the SAR 332 then sets the control signal 331 according to the latched comparator 330 output signal COMP 336 (or a stored indication thereof) for a new processing cycle.

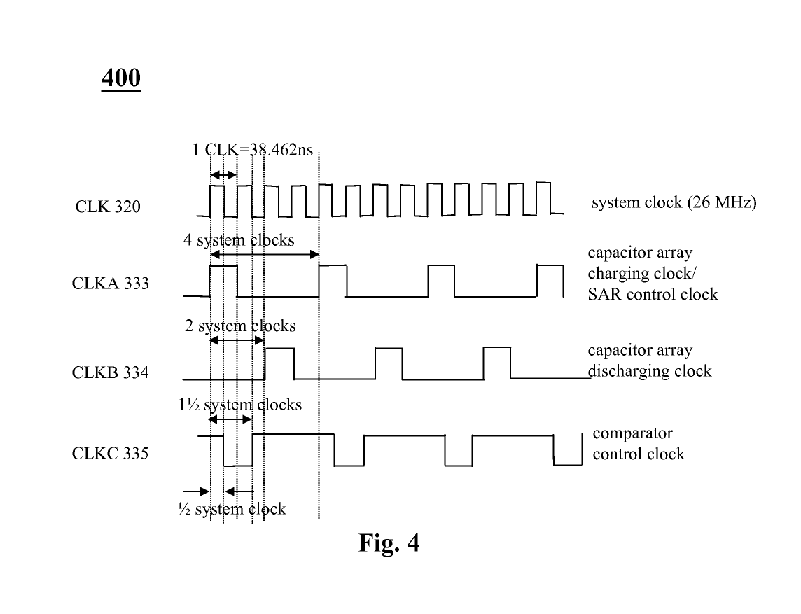

FIG. 4 is a timing diagram 400 showing one implementation of the clock signals CLKA 333, CLKB 334, and CLKC 335. In the example shown, CLK 320 is a 26 MHz digital system clock from a 26 MHz crystal oscillator. CLKA 333 is high for one full cycle of CLK 320 (38.462 ns) and low for three cycles of CLK 320 (115.385 ns) to provide a calibration processing period of four cycles of CLK 320 (153.848 ns). CLKB 334 can be the same clock signal as CLKA 333 except delayed by two cycles of CLK 320 (76.924 ns). CLKC 335 can be an inverted clock of CLKA 333 and delayed by one half of a cycle of CLK 320 (19.231 ns). R_{ref1}, and R_{ref2}, can be configured to provide a value of V_{ref} that enables tuning of the filter 300 to a predetermined time constant.

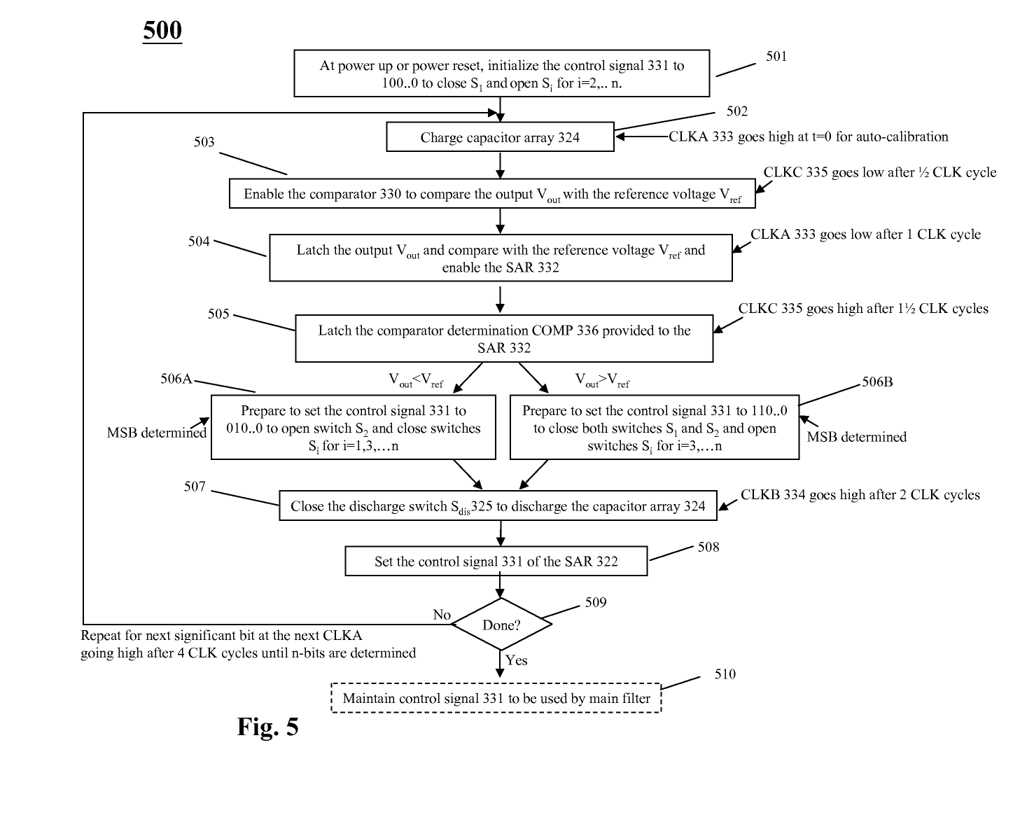

FIG. 5 is a flow chart of an example of a process 500 performed by the filter 300 when the clocks shown in the diagram 400 are employed. The process 500 describes the iterative calibration of the adjustable capacitor array 324. The resulting control signal 331 is then used to set the capacitance in a scaled array used in the main device filter (e.g., the filter 200B). The process 500 can allow for the manufactured device to self-calibrate capacitors of the capacitor array in an RC filter without requiring human input or alteration of the device components, such as human selection or addition of capacitance to the device after manufacturing.

In the example described, C_{f} is set at 32*Cᵤₙᵢₜ and the Cᵢ's are set as C₁=2⁴*Cᵤₙᵢₜ, C₂=2³*Cᵤₙᵢₜ, C₃=2²*Cᵤₙᵢₜ, C₄=2*Cᵤₙᵢₜ, and C₅=1*Cᵤₙᵢₜ. The initial value of the control signal 331 is set at 10000 to close the switch for the capacitor C₁, while leaving the other switches open. The resulting initial total capacitance for the capacitor array 324 is C_{f}+C₁=48 Cᵤₙᵢₜ.

As the process 500 starts, the control signal 331 is used to close switch S₁ and open switches Sᵢ for values of “i” of 2 and greater. The control signal 331 can be initialized as a binary value of 100 . . . 0 (the MSB being 1 and all others being 0) to close S₁ and open Sᵢ for i=2, . . . n (501). Therefore, the total capacitance of the capacitor array 424 can initially be set to 48 Cᵤₙᵢₜ with the switch controlled by the MSB (S₁) closed to connect capacitor C₁ in parallel with the fixed capacitor 423 C_{f} and all other switches open to disconnect the other capacitors. This control signal 331 can be generated by the SAR 332 as a response to power up or power reset of a device.

When CLKA 333 goes high at t=0, the capacitor array 324 is charged (502). In particular, a rising edge of CLKA 333 (at t=0) enables the buffer 337 to apply CLKA 333 to the filter 300 to charge capacitors C₁ and C_{f} of the capacitor array 324 with the current through the resistor 322 for one full cycle of CLK 320, for example, 38.462 ns for a 26 MHz clock. At the falling edge of CLKA 333, the buffer 337 is disabled and the charging cycle is completed.

When CLKC 335 goes low after one half of a cycle of CLK 320 (19.231 ns), the falling edge of CLKC 335 enables the comparator 330 to compare the voltage at the inverting input 328 of the comparator 330 Vₒᵤₜ with V_{ref} (503).

When CLKA goes low after one cycle of CLK 320, the filter output Vₒᵤₜ is latched by disabling the buffer 337 and compared with the reference voltage V_{ref} and the SAR 332 is enabled (504). Specifically, the falling edge of CLKA 333 at one clock cycle of CLK 320 (38.462 ns) holds the voltage output Vₒᵤₜ of the filter 300 and enables the SAR 332. During this period, the comparator 330 also compares Vₒᵤₜ with V_{ref}.

When CLKC 335 goes high after one and a half cycles of CLK 320, the comparator 330 output signal COMP 336 is latched (505). In particular, the next rising edge of CLKC 335 at one and a half clock cycles of CLK 320 (57.692 ns) latches the comparator 330 determination of Vₒᵤₜ as higher or lower than the reference voltage V_{ref}. The high (digital 1) or low (digital 0) comparator 330 determination at the output signal COMP 336 is provided to the SAR 332.

If the latched comparator 330 determination indicates that the filter output 327 voltage Vₒᵤₜ (latched at, e.g. t=38.462 ns) is lower than the reference voltage V_{ref} at the inverting input 328 of the comparator 330, the SAR 332 prepares to set the control signal 331 to 0100 . . . 0 (506A) according to the comparator 330 determination output signal COMP 336. For example, a state of a state machine internal to the SAR 332 can trigger the SAR 332 to determine the appropriate next control signal 331 without actually changing the control signal 331 until a later state. The control signal 331 of 0100 . . . 0 will disconnect the capacitor C₁ by opening switch S₁, connect the capacitor C₂ by closing switch S₂, and open or maintain open switches S₃, S₄, and S₅.

On the other hand, if the latched comparator 330 determination indicates that the filter output 327 voltage Vₒᵤₜ (latched at, e.g. t=38.462 ns) is higher than the reference voltage V_{ref} at the inverting input 328 of the comparator 330, the SAR 332 prepares to set the control signal 331 to 1100 . . . 0 (506B) according to the comparator 330 determination output signal COMP 336. The control signal 331 of 1100 . . . 0 will leave the capacitor C₁ connected by maintaining switch S₁ closed, connect the capacitor C₂ by closing the switch S₂, and open or maintain open switches S₃, S₄, and S₅.

When CLKB 334 goes high after two cycles of CLK 320 the discharge switch S_{dis} 325 is closed to discharge the capacitor array 324 (507). In particular, a rising edge of CLKB 334 at t=76.924 ns closes the discharge switch S_{dis} 325 to start discharging the charged capacitors in the capacitor array 324 for a full clock cycle of CLK 320. In other implementations, rather than using the discharge switch S_{dis} 325, the SAR 332 sets the control signal 331 to all 1's to discharge any charged capacitors in the capacitor array 324.

After the completion of the discharge (507), the SAR 332 then sets the control signal 331 (508). For instance, a state of a state machine internal to the SAR 332 can trigger the SAR 332 to use the output determined in actions 506A (0100 . . . 0) or 506B (1100 . . . 0) to update the control signal 331. The states of the SAR 332 can be controlled through a control signal other than CLKA 333, CLKB 334, or CLKC 335.

In various implementations, the process 500 is iterated according to the number of bits of the “n” bit signal, and it is determined whether all bits of the n-bit control signal 331 have been adjusted as needed for calibration, e.g., whether the calibration is done (509). The MSB bit associated with S₁ and C₁ (the largest switched capacitor of the capacitor array 324) is first adjusted, and each iteration considers the next highest bit until reaching the LSB.

In this case, at the next rising edge of CLKA 333 after 4 cycles of CLK 320, the auto-calibration actions 502-508 are repeated to determine the next bit, bit 2 in this example, of the control signal 331. The process 500 can continue with this successive-approximate algorithm until all n bits, in this example n=5, are set. A counter can be used to track which bit of the “n” bit control signal 331 is being adjusted and this counter can be compared to the value of “n” to determine whether the calibration is done (509). In one implementation, the auto-calibration can be complete in 2 μs.

If the calibration is done, the control signal 331 can be maintained to be used to tune the time constant of a main filter or other additional filters, such as, the filter 200B (510). The main filter may be designed with a scaled version of the capacitor array 324. Therefore, the main filter time constant RₘₐᵢₙCₘₐᵢₙ can be a scaled constant of the auto-calibrated RC time constant (RₘₐᵢₙCₘₐᵢₙ=kRC where k is a scale factor and a positive number). In some implementations, the basic capacitance can be the unit capacitance Cᵤₙᵢₜ and the main filter capacitor array has capacitors of weighted unit capacitance scaled to the capacitor array 324. The clock timing and the number of bits set can vary in other implementations. The main filter can be implemented with multiple stages of single pole, double pole or multiple pole RC-filers.

The offset voltage of the comparator 330 can contribute to tuning error. The tuning error e_{tuning} can come from the comparator 330 offset voltage error e_{comp} and the system quantization error e_{q}. The root main square tuning cycle error can be calculated as e_{tuning}=(e_{comp}²+e_{q}²)^{1/2}. In various implementations, the offset error of the comparator 330 can be designed to be approximately 1.5%, the quantization error can be designed to be approximately 1%, therefore the tuning error can be approximately (1%²+1.5%²)^{1/2}≈1.87%. This value can be below the capacitor tolerance requirement for the FTA of WCDMA handsets. These techniques can be equivalent to tuning both the total capacitance C and the resistor R 322. The techniques described above can be used to calibrate time constant variations as a result of process variation and/or temperature variation

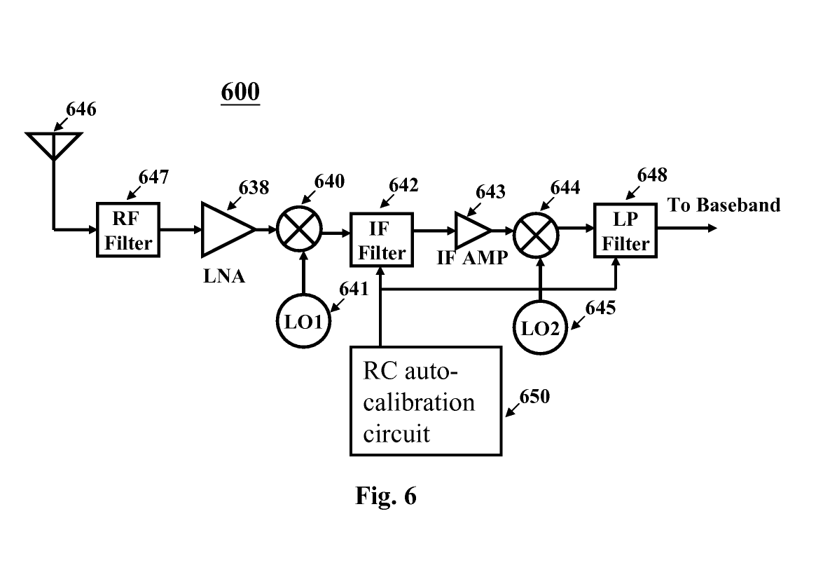

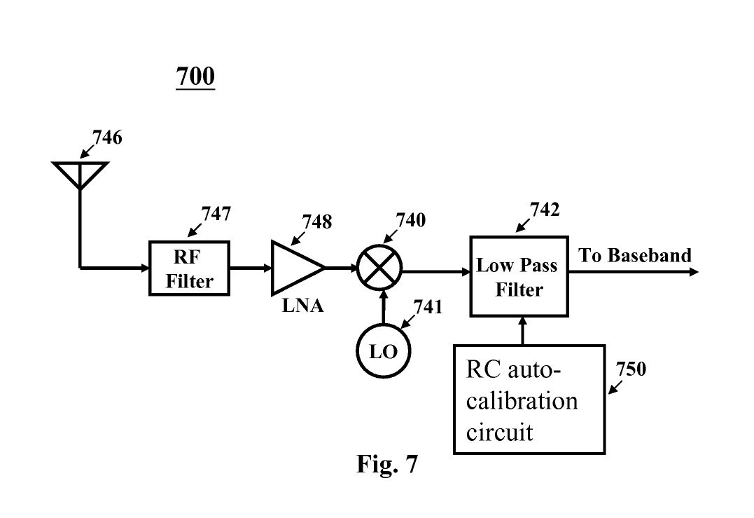

The disclosed techniques can be used with wireless communication systems. For example, the disclosed techniques can be used with receivers, transmitters, and transceivers, such as the receiver, transmitter, and/or transceiver architectures for superheterodyne receivers, image-rejection (e.g., Hartley, Weaver) receivers, zero-intermediate frequency (IF) receivers, low-IF receivers, direct-up transceivers, two-step up transceivers, and other types of receivers and transceivers for wireless and wireline technologies. FIGS. 6 and 7 are schematics demonstrating two examples of systems in which the auto-calibration techniques described above can be used.

In particular, FIG. 6 is a schematic of a low IF receiver 600. An RF signal arriving at an antenna 646 passes through a RF filter 647, a low noise amplifier (LNA) 638, and into first mixer 640, which translates the RF signal down to an intermediate frequency by mixing it with the signal produced by the first LO 641. The undesired mixer products in the IF signal are rejected by an IF filter 642 tuned by an auto-calibration circuit 650. The tuning with the auto-calibration circuit 650 can incorporate the features of the filter 300, the signals of the diagram 400 and the acts of the process 500, as described above with respect to FIGS. 3-5.

The filtered IF signal then enters an IF amplifier stage 643, after which the outputs feeds into the second mixer 644 that translates it down to yet another intermediate frequency by mixing it with the signal produced by a second LO 645. The signal is then sent to a second filter, low-pass filter 648, which can similarly be calibrated by the auto-calibration circuit 650 before further processing in the baseband. The filters 642 and 648 can be implemented as a single stage or multiple stages RC-filters where each filter stage has a scaled version of the capacitor array 324. Tuning into a particular channel within the band-limited RF signal is accomplished by varying the frequency of each LO 641 and 645.

In another example, FIG. 7 is a schematic of a direct-conversion receiver 700. An antenna 746 couples a RF signal through a first bandpass RF filter 747 into an LNA 748. The signal then enters a mixer 740 and mixes with an LO frequency produced by an LO 741 and passes through a low-pass filter 742. An auto-calibration filter circuit 750 calibrates the RC time constant of the low-pass filter 742. Specifically, the tuning with the auto-calibration circuit 750 can incorporate the features of the filter 300, the signals of the diagram 400 and the acts of the process 500, as described above with respect to FIGS. 3-5. The output signal of the low-pass filter 742 then proceeds into a baseband for use by the remainder of the communications system.

In other implementations, the resistor 322 having a resistance R can be replaced by a resistor array of a weighted unit resistors comprised of a fixed resistor and switched resistors, and this array can be used instead of, or in addition to, the capacitor array to alter the time constant. The techniques described above can then be applied to switching resistors in order to calibrate the RC constant. For instance, the filter 300 can incorporate a weighted unit resistor array rather than the capacitor array 324 and the signals of the diagram 400 can be used control the process 500 to similarly set the bits of the control signal 331 to switch resistors of the resistor array to tune the filter 300 (and alter its time constant).

In some implementations, the positions of switches, capacitors, resistors, and inductors can be exchanged from the disclosed figures with minimal change in circuit functionality. Various topologies for circuit models can also be used, other than what is shown in the figures. The exemplary designs shown are not limited to CMOS process technology, but may also use other process technologies, such as BiCMOS (Bipolar-CMOS) process technology, or Silicon Germanium (SiGe) technology. In some implementations, switches can be implemented as transmission gate switches. The circuits can be single-ended or fully-differential circuits. The system can include other components, where the circuit can couple with those components. Some of the components may include computers, processors, clocks, radios, signal generators, counters, test and measurement equipment, function generators, oscilloscopes, phase-locked loops, frequency synthesizers, phones, wireless communication devices, and components for the production and transmission of audio, video, and other data.

What is claimed is:

1. A circuit comprising:
a filter configured to receive a filter charging signal and to produce a filter output signal based on the filter charging signal, the filter including an element array with one or more switched elements, each switched element including an element and a switch configured to connect the element to or disconnect the element from the array, wherein connecting elements to or disconnecting elements from the element array alters a time constant of the filter;
a comparator configured to receive the filter output signal and a reference signal and to generate a comparator output signal based on a comparison of the filter output signal to the reference signal, the reference signal corresponding to a value of the filter output when the time constant has a defined value;
a controller configured to receive the comparator output signal and, based on the comparator output signal, output an array control signal configured to adjust one or more switches of the one or more switched elements of the element array to alter the time constant such that a value of the time constant approaches the defined value.

2. The circuit of claim 1 wherein the element array is a capacitor array and each switched element includes a capacitor and a switch.

3. The circuit of claim 2 further comprising a fixed capacitor coupled in parallel to the capacitors of the capacitor array, wherein the fixed capacitor is not within a switched element of the capacitor array.

4. The circuit of claim 3 further comprising a discharge switch coupled to the capacitor array and the fixed capacitor and configured to discharge the fixed capacitor and the capacitors of the one or more switched capacitors based on a discharge signal.

5. The circuit of claim 2 further comprising a discharge switch coupled to the capacitor array and configured to discharge the capacitors of the one or more switched capacitors based on a discharge signal.

6. The circuit of claim 1 wherein the array control signal is an “n” bit signal and each bit is coupled to a respective control input of each switch of the switched elements, wherein “n” is the number of switched elements.

7. The circuit of claim 6 wherein the controller is configured to adjust, sequentially over “n” one bit adjustment cycles, each bit of the “n” bit array control signal based on the comparator output signal.

8. The circuit of claim 1 wherein the controller is configured to output the array control signal to one or more additional element arrays which are connected to one or more additional filters.

9. The circuit of claim 8 wherein the one or more additional filters include a k-pole RC filter.

10. The circuit of claim 1 wherein the reference signal is a voltage which would be output by the filter at the time the comparator generates a comparator output signal if the value of the time constant of the filter is equal to the defined value.

11. The circuit of claim 1 wherein the controller includes a successive approximation register.

12. The circuit of claim 1 wherein the controller includes a state machine.

13. The circuit of claim 1 further comprising a timing generator configured to receive a system clock signal and to generate the filter charging signal, a comparator control signal, and a controller control signal based on the received system clock.

14. The circuit of claim 13 wherein the filter charging signal and the controller control signal are generated as one signal output which is received at to both the filter and the controller.

15. The circuit of claim 1 wherein the filter is a single-pole RC-filter.

16. The circuit of claim 1 further comprising a voltage divider to generate the reference signal as a ratio of a supply voltage.

17. A method comprising:
applying a filter charging signal to an input of a filter to produce a filter output based on the filter charging signal, wherein the filter includes an element array with one or more switched elements, each switched element including an element and a switch configured to connect the element to or disconnect the element from the array, wherein connecting elements to or disconnecting elements from the element array alters a time constant of the filter;
applying the filter output to a first input of a comparator;
applying a reference signal to a second input of the comparator, the reference signal corresponding to a value of the filter output when the time constant has a defined value;
comparing the filter output to the reference signal using the comparator to generate a comparator output signal;
applying the comparator output signal to a controller;
adjusting, with the controller and based on the comparator output signal, one or more switches of the one or more switched elements of the element array to alter the time constant based on the comparator output such that a value of the time constant approaches the defined value.

18. The method of claim 17 wherein the element array is a capacitor array and each switched element includes a capacitor and a switch.

19. The method of claim 18 wherein the filter includes a fixed capacitor outside of and coupled in parallel to the switched elements of the capacitor array.

20. The method of claim 19 further comprising discharging the fixed capacitor and the capacitors of the one or more switched capacitors with a discharge signal input to a discharge switch coupled to the capacitor array and the fixed capacitor.

21. The method of claim 18 further comprising discharging the capacitors of the one or more switched capacitors with a discharge signal input to a discharge switch coupled to the capacitor array.

22. The method of claim 17 further comprising generating, at the controller, an “n” bit array control signal, wherein each bit of the array control signal is coupled to a respective control input of each switch of the switched elements and “n” is the number of switched elements.

23. The method of claim 22 further comprising adjusting, sequentially over “n” one bit adjustment cycles, each bit of the “n” bit array control signal based on the comparator output signal.

24. The method of claim 17 further comprising applying the array control signal to one or more additional element arrays which are connected to one or more additional filters.

25. The method of claim 24 wherein the one or more additional filters include a k-pole RC filter.

26. The method of claim 17 wherein the reference signal is a voltage which would be output by the filter at the time the comparator generates a comparator output signal if the value of the time constant of the filter is equal to the defined value.

27. The method of claim 17 wherein the controller includes a successive approximation register.

28. The method of claim 17 wherein the controller includes a state machine.

29. The method of claim 17 further comprising:
receiving a system clock signal at a timing generator; and
generating, at the timing generator and based on the received system clock signal, the filter charging signal, a comparator control signal, and a controller control signal.

30. The method of claim 29 wherein generating the filter charging signal and the controller control signal includes generating one signal output which is received at both the filter and the controller.

31. The method of claim 17 wherein the filter is a single-pole RC-filter.

32. The method of claim 17 further comprising generating the reference signal as a ratio of a supply voltage with a voltage divider.

33. A system comprising:
a radio frequency (RF) input signal received by an antenna coupled to an RF filter;
a low noise amplifier (LNA) configured to amplify the RF input signal after it has been received by the antenna;
a mixer configured to perform image rejection and mix, with an output of a first local oscillator, the RF input signal after it has been amplified by the LNA;
a first filter configured to filter the RF input signal after it has been mixed by the mixer, wherein the first filter includes a first element array which is configured to be adjusted based on an array control signal from an array controller;
a second filter configured to filter the RF input signal after it has been filtered by the first filter, wherein the second filter includes a second element array which is configured to be adjusted based on the array control signal from the array controller;
a calibration filter configured to receive a calibration filter charging signal and to produce a calibration filter output signal based on the calibration filter charging signal, the calibration filter including a calibration element array with one or more switched elements, each switched element including an element and a switch configured to connect the element to or disconnect the element from the calibration element array;
a comparator configured to receive the calibration filter output signal and a reference signal and to generate a comparator output signal based on a comparison of the calibration filter output signal to the reference signal; and
a controller configured to receive the comparator output signal and, based on the comparator output signal, output the array control signal, wherein the array control signal is configured to adjust one or more switches of the first, second, and calibration element arrays.
